(19) United States
(12) Patent Application Publication
(10) Pub. No.: US 2019/0073600 A1
(43) Pub. Date: Mar. 7, 2019

(54) SKIPPING MAINTENANCE MODE OF APPLICATIONS

(71) Applicant: SAP SE, Walldorf (DE)

(72) Inventors: Stoyan Boshev, Sofia (BG); Todor Stoyanov, Sofia (BG)

(21) Appl. No.: 15/694,853

(22) Filed: Sep. 4, 2017

(51) Int. Cl. G06N 5/04

(52) U.S. Cl. CPC G06N 5/046; G06F 8/65

(57) ABSTRACT

Methods and system are disclosed that bypass a maintenance mode of an application, for some users. In one aspect, multiple requests may be received to establishing a connection with multiple applications at a load balancer component. Upon receiving the received requests, a request processing and inspection unit and an intelligent control unit may be instantiated. The request processing and inspection unit may preprocess or process the received requests. The preprocessed or processed requests may be forward to the intelligent control unit. Based on a determination of header information and a content of the received requests, the intelligent control unit may determine whether to execute a routine to bypass a maintenance mode of an application and direct the requests to establish connection with the application or to execute a routine related to the maintenance mode of the application.

### BACKGROUND

Typically, applications are put in maintenance mode while undergoing major upgrades of features and functionalities. Under such circumstances, applications may not be accessible or available for consumption by users. However, some users may need to access the application to execute some tasks such as executing validation routines, debug some features or functionalities of the application, etc., when the application is in the maintenance mode. Provisioning an independent infrastructure for accessing the application and executing aforementioned tasks, when the application is in maintenance mode may have drawbacks such as, increased complexity with multiple points of communication, inefficient system operation due lags or delays, etc., thereby adding redundancy and an overall increase in the infrastructure costs. Therefore, providing a mechanism that may be integrated with an existing system to execute the aforementioned tasks, when the application in the maintenance mode and overcome the above drawbacks, may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating a mechanism to bypass maintenance mode of an application, according to an embodiment.

FIG. 2 is a block diagram illustrating a system to bypass maintenance mode for an application, according to an embodiment.

FIG. 3 is a flow diagram illustrating a process to bypass maintenance mode for an application, according to an embodiment.

FIG. 4 is a block diagram illustrating a computer system, according to an embodiment.

### DETAILED DESCRIPTION

Embodiments of techniques related to skipping maintenance mode of applications are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a feature, structure, or characteristic described in connection with the embodiment is included in at least one of the one or more embodiments. Thus, the appearances of these phrases in various places throughout this specification are not necessarily all referring to the same embodiment. Furthermore, the features, structures, or characteristics may be combined in any suitable manner in one or more embodiments.

A system administrator for an application may occasionally configure the application to enter into maintenance mode. The application may be in the maintenance mode or associated with the maintenance mode or may enter into the maintenance mode, when the application undergoes software bug fixes, deployment of additional functionalities, deployment of security features, a major upgrade in terms of features and functionalities, etc. In some instances, the system administrator may intentionally put the application in maintenance mode during which the application may be accessible only by a subset of authorized one or more users. In an embodiment, a mechanism may be provided to determine whether a user is authorized to access the application, when the application is in maintenance mode. The mechanism may display information related to the maintenance mode to unauthorized users, when the application is in maintenance mode.

In an embodiment, the terms software components or components, software routines or routines, software models or models, software engines or engines, software scripts or scripts, layers etc., are employed interchangeably throughout the subject specification, unless context warrants particular distinction(s) among the terms depending on implementation. The implementation primarily involves executing a computer readable code such as, a sequence of instructions by a processor of a computing device (e.g., a special purpose computer, a general-purpose computer, mobile device, etc.) in an integrated environment. The computing device may function as the special purpose computer when the memory in the computing device stores instructions which when executed by the processor, provide execution of specific operations or functionalities (e.g., instantiating a request processing and inspection unit, an intelligent control unit, determining the content and header information in the requests, segregating the header information and the content of the request, sending or forwarding the segregated header information and the content to the intelligent control unit, determining a presence or an absence of an identifier and a unique value of the identifier in the header information, etc., may facilitate the functioning of the computing device as the special purpose computer). In some instances, the memory may store instructions that may not be limited to the aforementioned specific operations or functionalities. Unless the context warrants particular distinction(s), the cooperative execution of the above described operations or functionalities may improve the functioning of the special purpose computer. Further the special purpose computer may be adapted to perform operations or functionalities (e.g., as described above) that were not performed previously. Further, the execution of the aforementioned specific operations or functionalities also overcome the drawbacks or challenges. Furthermore, the adaptation of the computing device to function as the special purpose computer may include executing the instructions to implement a mechanism to determine whether to instantiate and execute a routine for bypassing or skipping the maintenance mode of the application or to instantiate and execute the routine related to the maintenance mode of the application. In an embodiment, the above models, software components, software routines, etc., may be reused based on definition and implementation.

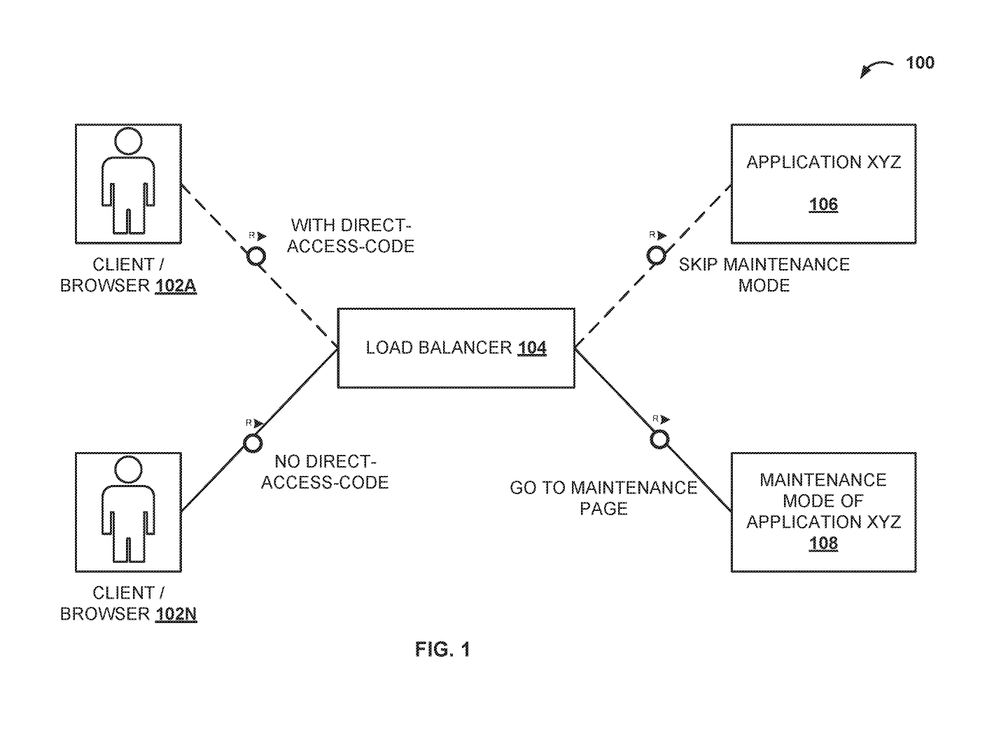

FIG. 1 is a block diagram illustrating a mechanism to bypass a maintenance mode of an application. The mechanism may be implemented on an application delivery networking system that delivers web applications, provides security, provides data storage devices and other cloud computing resources. In an embodiment, the application delivery networking system may include load balancer 104 (also referred to as load balancer component) integrated to work in cooperation with a request processing and inspection unit (not shown) and an intelligent control unit (e.g., iRule component of BIG IP provided by F5 Networks, Inc; not shown). The intelligent control unit may be configured with multiple rules (e.g., defined or configured by users) using a combination of relational operators (e.g., >, <, =, >=, <=, etc.), logical operators (e.g., AND, OR, etc.), etc. to process the received requests and execute specific operations by the application delivery networking system.

In an embodiment, the users may initiate request(s) (e.g., the requests may be transmitted over the network using hypertext transfer protocol (http)) for establishing connection(s) with the applications via an interface (e.g., client interface, browsers, etc.; client/browsers 102A . . . 102N) over a network (e.g., the Internet). The requests initiated by the users may be received at load balancer 104 of the application delivery networking system. In an embodiment, the request processing and inspection unit working in cooperation with load balancer 104 may preprocess the received requests by parsing the requests, determining and segregating the header information and the content of the received requests. In an embodiment, the header information and the content embedded in the requests may include an identifier, a unique value of the identifier, user identifiers, application group identifiers, etc.

The intelligent control unit may parse the header information to determine a presence (e.g., with direct-access-code) or an absence (or no direct-access-code) of the identifier and the unique value of the identifier in the header information, and other attributes, attribute values, parameters, parameters values, etc., in the content of the received requests. Based on the determined attributes, attribute values and the header information (e.g., identifier and unique value of the identifier), the intelligent control unit may determine whether to execute a routine to bypass the maintenance mode (e.g., skip maintenance mode) and direct the requests to the application (e.g., application XYZ 106) or to execute a routine related to the maintenance mode (e.g., go to maintenance page (user interface)) of the application (e.g., maintenance mode of application XYZ 108). The above responses may include determinations performed by the intelligent control unit, when cooperatively working with load balancer 104 and the request processing and inspection unit. In response to the determinations by intelligent control unit, the requests may be processed and be directed to bypass the maintenance mode and establish connection with the applications at the backend (e.g., application XYZ 106) or to a user interface displaying a maintenance information associated with the application (e.g., maintenance mode of application XYZ 108).

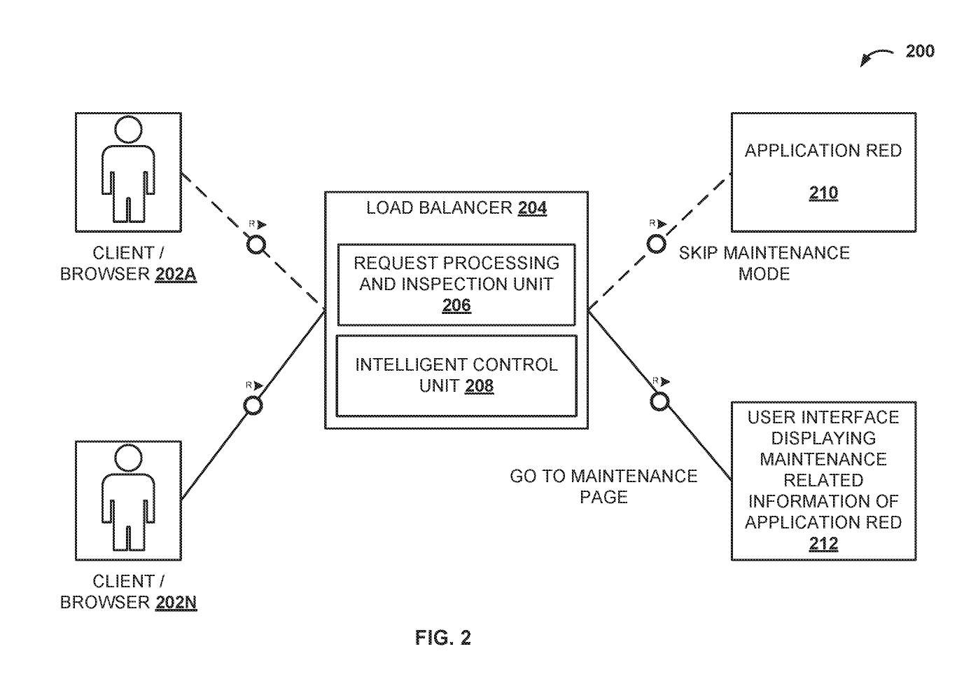

FIG. 2 is a block diagram illustrating system 200 to bypass a maintenance mode for an application, according to an embodiment. FIG. 2 shows system 200 implementing a mechanism to bypass or skip a maintenance mode, when an application is in the maintenance mode. In an embodiment, when the application is in the maintenance mode, the application may not be accessible or available for utility or consumption to the users. In another example, the application may be in the maintenance mode during a disaster recovery test. When the application is in the maintenance mode during the disaster recovery test, it may prevent the users from using the application to modify data, execute operations, etc., which may subsequently be lost on completion of the disaster recovery test. However, there may be circumstances when some of the users may need to use or consume the application to execute some validation routines (e.g., once the application has been updated with new features or functionalities), fix software bugs related to features and functionalities, tweak or optimize some routines of the application, execute some load/stress performance related tests, etc., when the application is in the maintenance mode. In an embodiment, a mechanism may be provided, such that certain users may be able to access the application by skipping or bypassing the application maintenance mode and execute the above tasks on the application.

In an embodiment, system 200 implementing the mechanism to bypass or skip the maintenance mode for the application may include load balancer 204 integrated to work in cooperation with request processing and inspection unit 206 and intelligent control unit 208. The cooperative working of the above components and the units (e.g., load balancer 204, request processing and inspection unit 206, intelligent control unit 208, etc.) may provide execution of specific operations or functionalities. In an embodiment, load balancer 204 may be communicatively coupled with multiple applications (e.g., application red 210) deployed at the backend over the network (e.g., the Internet, local area network (LAN), wide area network (WAN), etc.). The system 200 implementing the mechanism to bypass the maintenance mode for the application (e.g., 210) may either be deployed in a distributed computing environment (e.g., cloud computing environment) or an on-premise environment and likewise the application (e.g., 210) at the backend may be deployed in the cloud computing environment or the on-premise environment.

In an embodiment, user(s) may initiate a single request or multiple requests (also referred to as requests) for establishing connection(s) with a single application or multiple applications via an interface over a network (e.g., the Internet World Wide Web (www), etc.). For example, the requests for establishing connections may be initiated via web browsers or user/client interfaces (e.g., 202A . . . 202N) of the applications over the Internet. The requests initiated by the users over the network may be received at load balancer 204. For example, the requests may be initiated for establishing connections with the application (e.g., 210) deployed at the backend and execute specific functionalities or operations or tasks, such as, executing software updates or patches, executing validation routines, executing security patches, etc. In an embodiment, when the requests are received at load balancer 204, request processing and inspection unit 206 and intelligent control unit 208 working in cooperation with load balancer 204, may be instantiated.

The request processing and inspection unit 206 at load balancer 204 may preprocess the received requests. The preprocessing or processing the request by request processing and inspection unit 206 may include parsing the requests to determine content including metadata information, attributes, attribute values, parameters, parameter values, internet protocol (IP) addresses, source addresses, destination addresses, etc. (also referred to as the content), and a header information in the requests. For example, request processing and inspection unit 206 may parse the requests to determine and segregate the header information and the content of the received requests, which may be forwarded to the intelligent control unit. In an embodiment, the header information may include multiple fields, for example, request and response fields with a corresponding parameters and parameter values, identifiers and unique identifier values, etc., and the content may also include application group identifiers, user identifiers, etc. In an embodiment, request processing and inspection unit 206 may extract the header information and the content from the requests and forward the header information and the content to the intelligent control unit.

In an embodiment, intelligent control unit 208 may receive the preprocessed request from request processing and inspection unit 206. The intelligent control unit 208 may determine various parameters, fields, and their respective values, including whether the received header information includes a combination of an identifier (e.g., with direct-access-code) and a unique value of the identifier. For example, such an identifier in the received request may correspond to “Direct-Access-Code” and the unique value of the identifier may be alphanumeric characters (e.g., combination of set of the 26 alphabetic characters, A to Z in upper-case and lower-case characters, 10 Arabic numerals, 0 to 9; punctuation marks or symbols or special characters, such as—!, @, #, $, %, ̂, &, *; etc.) of a predefined size (e.g., predefined size of 5 characters, 10 characters, 50 characters, 100 characters, etc.). In an embodiment, based on an authorization credentials associated with the user identifiers, the identifier and the unique value of the identifier may be embedded in the requests initiated by the users. The above identifier and the unique value of the identifier may provide an additional layer of security and authorization of the users, who may access and use the application, when the application is in maintenance mode. For example, initially a system administrator for the application may configure and associate the identifier and the unique value of the identifier for some users (e.g., selectively configure), based on user identifiers, application group identifiers, authorization credentials associated with the user identifiers, etc. The associated and configured identifier and the unique value of the identifier may be stored in a data structure (e.g., array, memory, table, flat file, etc.) associated with the load balancer component.

In an embodiment, upon determining the identifier and the unique value of the identifier in the received requests, intelligent control unit 208 may determine attributes and attribute values from the content in the request. For example, such attributes and attribute values may include the user identifiers, user identifier values, application group identifiers, application group identifier values, etc. Based on the determined attributes, attribute values and the header information (e.g., identifier and unique value of the identifier), the response of the intelligent control unit may instantiate a routine and execute a corresponding functionality or operation. For example, based on the above determinations, the response of intelligent control unit 208 may determine whether to instantiate and execute a routine to bypass the maintenance mode and direct the requests to the application (e.g., 210) or to instantiate and execute a routine related to the maintenance mode of the application red (e.g., 212).

In an embodiment, intelligent control unit 208 may determine the execution of the above routines based on a decision logic. For example, the decision logic may be based on a comparison of the identifier and the unique value of the identifier stored in the data structure associated with load balancer 204 with the identifier and the unique value of the identifier embedded in the header information in the requests. In an embodiment, on determination of the match between the identifier and the unique value of the identifier embedded in the request with the corresponding identifier and the unique value of the identifier stored in the data structure associated with load balancer 204, intelligent control unit 208 may instantiate and execute the routine for bypassing or skipping the maintenance mode (e.g., skip maintenance mode) and direct the requests to the application (e.g., 210) or to instantiate and execute the routine related to the maintenance mode of the application (e.g., go to maintenance page) and display user interface including information related to the maintenance mode of the application (e.g., 212).

For example, suppose that “John”, “Jeff”, and “Jack” are employees of an organization ‘X’ with respective user identifiers as ‘ABC-123’, ‘ABZ-345’, and ‘QWE-234’, authorized to access an application with the application group identifier ‘XYZ-890’. Suppose that “John” is authorized to access the application with the application group identifier ‘XYZ-890’, even when the application is in the maintenance mode, while “Jeff” and “Jack” are not authorized to access the application in the maintenance mode. Under such circumstances, the system administrator for the application with the application group identifier ‘XYZ-890’ may generate, configure and associate an identifier, e.g., “Direct-Access-Code”, and a unique value of the identifier, e.g., “P@assword20”, with the user identifier ‘ABC-123’ of “John”. This association and relevant information may be stored in the data structure associated with the load balancer component. In an embodiment, whenever “John” initiates a request via the application delivery networking system, to access or establish a connection with the application with the application group identifier ‘XYZ-890’, the above identifier (“Direct-Access-Code”) and the unique value of the identifier associated with “John's” user identifier (“P@assword20”) maybe automatically embedded in the header information of the request, along with the other content, for example, the user identifier, application group identifier, etc., in the request. In an embodiment, when the application is not in maintenance mode, the application may provide a mechanism that may authenticate or authorize the users based on user credentials. The embedding of the identifier and the unique value in the requests for some authorized users, may provide additional privileges and may further be used to provide access to the application, when the application is in the maintenance mode. The above referenced authorization may be executed during the application runtime.

For example, consider that the application with the application group identifier ‘XYZ-890’ enters into maintenance mode and “John” intends to access the application and execute some validation routines on the application with the application group identifier ‘XYZ-890.’ When “John” initiates a request to connect with the application with the application group identifier ‘XYZ-890’, the request may be received at the load balancer component. The request may be preprocessed or processed at the request processing and inspection unit which may extract the header information and segregate the content from the request and forward the header information and the content to the intelligent control unit. Upon processing the received header information, the intelligent control unit may determine whether the header information of the request includes the combination of the identifier (e.g., “Direct-Access-Code”) and the unique value of the identifier (e.g., “P@assword20”). In another embodiment, the intelligent control unit may parse the content of the received request to determine that the request was initiated by “John”, based on the user identifier (e.g., ‘ABC-123’) and the application group identifier ‘XYZ-890’. In an embodiment, subsequent to the aforementioned determinations, the intelligent control unit may access the data structure associated with the load balancer component and retrieve the identifier and the unique value of the identifier from the data structure. The intelligent control unit may compare the retrieved corresponding information with the identifier and unique value of the identifier embedded in the header information of the received request. Based on the above comparison, when the intelligent control unit determines a match between the identifier (e.g., “Direct-Access-Code”) and the unique value of the identifier (e.g., “P@assword20”) from the header information in the received request with the corresponding identifier and the unique value of the identifier retrieved from the data structure, the intelligent control unit determines that “John” is authorized to access the application with the application group identifier ‘XYZ-890,’ when the application is in the maintenance mode. Upon such determination, the intelligent control unit may instantiate and execute the routine to bypass or skip the maintenance mode and direct “John's” request to establish the connection with the application with the application group identifier ‘XYZ-890’, while the aforementioned application is in the maintenance mode. In an embodiment, the above data structure (e.g., table) may further include data fields (e.g., in rows and columns) storing a mapping information. For some authorized users, such mapping information may include a correspondence between the user identifier, the identifier and the unique value of the identifier. The intelligent control unit may use the mapping information to execute the above matching and determine whether to provide access to the user, when the application in maintenance mode.

For example, consider that the application with the application group identifier ‘XYZ-890’ enters into maintenance mode and “Jeff” intends to access the application with the application group identifier ‘XYZ-890.’ Suppose that “Jeff” partially learns that the maintenance mode for the application may be bypassed or skipped, by embedding an identifier and unique value of the identifier in the request. Suppose that “Jeff” is able to manipulate and use this information by successfully embedding the identifier and the unique value of the identifier with his request to connect with the application with the application group identifier ‘XYZ-890.’ In an embodiment, the request initiated by ‘Jeff’ may be received at the load balancer component and the request may be preprocessed or processed at the request processing and inspection unit, which may extract the header information and the content from the request and forward the header information and the content to the intelligent control unit. Upon processing the received header information, the intelligent control unit may determine the header information of the request includes a combination of the identifier (e.g., “Direct-Access-Code”) and the unique value of the identifier (e.g., “W % word20”). Further the intelligent control unit may parse the content of the received request to determine that the request was initiated by “Jeff”, based on his user identifier and the application group identifier ‘XYZ-890’. In an embodiment, subsequently the intelligent control may access the data structure associated with the load balancer component and retrieve the identifier and the unique value of the identifier from the data structure. However, since “Jeff” is not authorized to access the application in the maintenance mode, the system administrator for the application group identifier ‘XYZ-890’ did not configure, associate and store the identifier: “Direct-Access-Code” and the unique value of the identifier: “W % word20” for “Jeff” in the data structure associated with the load balancer component. Based on such determinations, the intelligent control unit may further determine that “Jeff” is authorized to access the application with the application group identifier ‘XYZ-890,’ when the application is in the maintenance mode. In response, the intelligent control unit may instantiate and execute the routine related to the maintenance mode and direct “Jeff's” request to a user interface showing information related to the maintenance mode associated with the application with the application group identifier ‘XYZ-890’.

For example, consider that the application with the application group identifier ‘XYZ-890’ enters into maintenance mode and “Jack” intends to access the application and execute some validation routines on the application with the application group identifier ‘XYZ-890.’ When “Jack” initiates a request to connect with the application with the application group identifier ‘XYZ-890’, the request may be received at the load balancer component. The request may be preprocessed or processed at the request processing and inspection unit which may extract the header information and segregate the content from the request and forward the header information and the content to the intelligent control unit. Upon processing the received header information, the intelligent control unit may determine the header information of the request does not include the combination of identifier and the unique value of the identifier. The header information of the request initiated by “Jack” does not include the combination identifier and the unique value of the identifier, as “Jack” was not authorized to access the application during the maintenance mode. Accordingly, the system administrator for the application with the application group identifier did not associate and configure the identifier and the unique value of the identifier with the user identifier of “Jack”. In an embodiment, when the intelligent control unit determines that the identifier and the unique value of the identifier are not present in the header information of the request initiated by “Jack”, the intelligent control unit may instantiate and execute the routine related to the maintenance mode and direct “Jack's” request to display a user interface including the maintenance information associated with the application with the application group identifier ‘XYZ-890’.

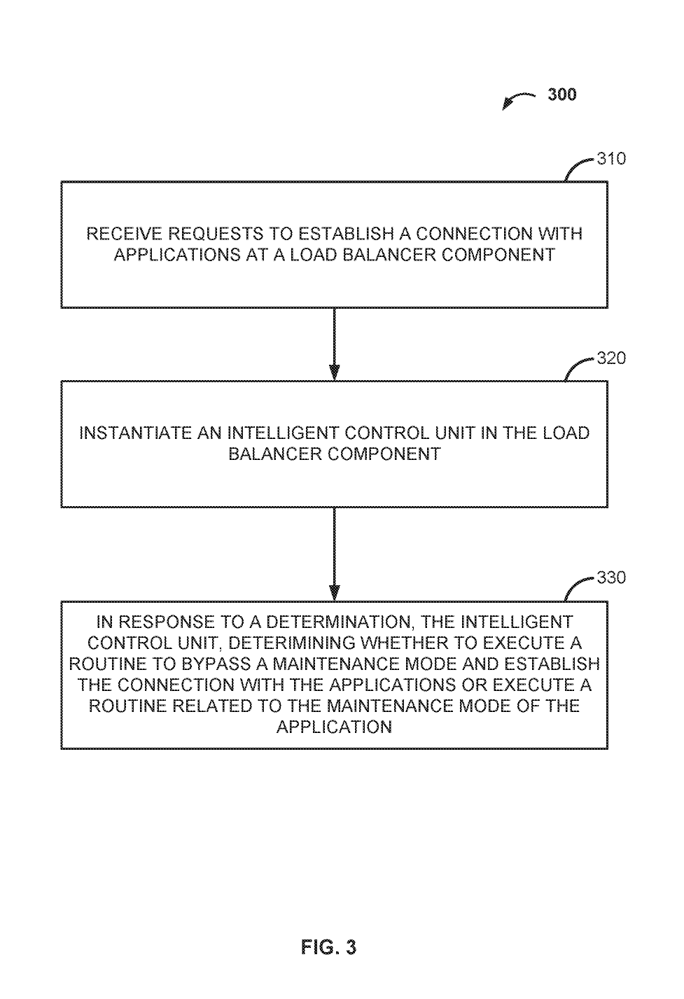

FIG. 3 is a flow diagram illustrating process 300 to bypass a maintenance mode for an application, according to an embodiment. In an embodiment, a mechanism to bypass or skip maintenance mode for an application for some users, may be provided. The efficacies of the load balancer component, the request processing and inspection unit, the intelligent control unit, etc., in terms of operational and functionalities with concurrent supporting examples in process 300 are as explained previously. In an embodiment, multiple requests for establishing a connection with multiple applications is received at a load balancer component, at 310. Upon receiving the requests, the intelligent control unit is instantiated in the load balancer component, at 320. In response to a determination, the instantiated intelligent control unit determining whether to execute a routine to bypass a maintenance mode and direct the requests to establish the connection with the applications or to execute a routine related to the maintenance mode of the application, at 330.

In an embodiment, the above mechanism to bypass or skip the maintenance mode for the application may overcome the drawbacks, as discussed previously. The design and implementation complexity provided by the above mechanism for accessing the application, when the application is in the maintenance mode, is simplified as it eliminates the need of the independent infrastructure with multiple points of communication in the system. Further, such simplicity in the implementation of the above mechanism increases the efficiency, eliminates redundancy, the execution time for processing requests and executing operations or functionalities and hence reducing the overall infrastructure deployment costs. Further, the above described mechanism may also provide enhancements or improvements in the system as an additional level of security or authorization for accessing the applications. For example, the configuration of the identifier and the unique value of the identifier may provide an additional layer of security for accessing the application, thereby eliminating the need for additional infrastructure for authorization and reducing the overall costs. In an embodiment, the configuration of the identifier and the unique value of the identifier may also be used to provide multi-form authentication to validate the user for accessing the application. For example, the authorized users may be provided the identifier and the unique value of the identifier via an email, text message, etc., and subsequently the users may be prompted to input the identifier and the unique value of the identifier for authentication. For example, when the users try to access the application, a user interface may be provided by the application that may prompt the users to input the identifier and the unique value of the identifier, thereby providing the additional layer of security or validation for accessing the application.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

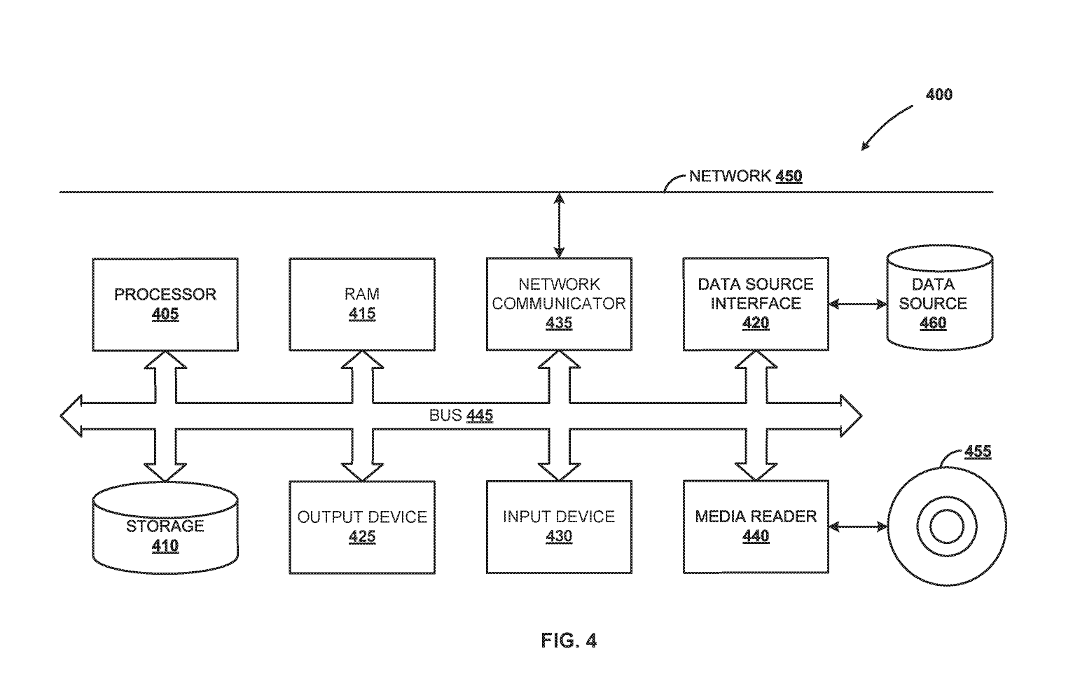

FIG. 4 is a block diagram illustrating a computer system 400, according to an embodiment. Computer system 400 includes processor 405 that executes software instructions or code stored on computer readable storage medium 455 to perform the above-illustrated methods. Processor 405 can include a plurality of cores. Computer system 400 includes media reader 440 to read the instructions from computer readable storage medium 455 and store the instructions in storage 410 or in random access memory (RAM) 415. Storage 410 provides a large space for keeping static data where at least some instructions could be stored for later execution. According to some embodiments, such as some in-memory computing system embodiments, RAM 415 can have sufficient storage capacity to store much of the data required for processing in RAM 415 instead of in storage 410. In some embodiments, all of the data required for processing may be stored in RAM 415. The stored instructions may be further compiled to generate other representations of the instructions and dynamically stored in RAM 415. Processor 405 reads instructions from RAM 415 and performs actions as instructed. According to one embodiment, computer system 400 further includes output device 425 (e.g., a display) to provide at least some of the results of the execution as output including, but not limited to, visual information to users and input device 430 to provide a user or another device with means for entering data and/or otherwise interact with computer system 400. Each of these output devices 425 and input devices 430 could be joined by one or more additional peripherals to further expand the capabilities of computer system 400. Network communicator 435 may be provided to connect computer system 400 to network 450 and in turn to other devices connected to network 450 including other clients, servers, data stores, and interfaces, for instance. The modules of computer system 400 are interconnected via bus 445. Computer system 400 includes a data source interface 420 to access data source 460. Data source 460 can be accessed via one or more abstraction layers implemented in hardware or software. For example, data source 460 may be accessed by network 450. In some embodiments data source 460 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer system to bypass a maintenance mode for an application, comprising:
a memory storing computer instructions; and
a processor communicatively coupled with the memory to execute the instructions to perform operations, comprising:
receive one or more requests to establish a connection with one or more applications at a load balancer component;
upon receiving the one or more requests, instantiate an intelligent control unit in the load balancer component; and
in response to a determination, the instantiated intelligent control unit determining whether:
to execute a routine to bypass a maintenance mode and direct the one or more requests to establish the connection with the one or more applications; or
to execute a routine related to the maintenance mode of the one or more applications.

2. The computer system of claim 1, further comprising: a request processing and inspection unit at the load balancer component to:
preprocess the received one or more requests, wherein the preprocessing includes parsing the one or more requests including a content and a header information in the one or more requests;
extract the header information from the one or more requests; and
forward the extracted header information from the one or more requests to the intelligent control unit.

3. The computer system of claim 1, further comprising:
from the forwarded header information, determine whether the header information includes a combination of a first identifier and a unique value of the first identifier;
determine one or more attributes in the received one or more requests at the intelligent control unit, wherein the one or more attributes are associated with one or more user identifiers, and one or more application group identifiers; and
based on the determined one or more attributes in the received request in the one or more requests and the determined header information, determine the response by the intelligent control unit.

4. The computer system of claim 1, further comprising:
for one or more users, selectively configure a second identifier and a unique value of the second identifier based on the one or more user identifiers and the one or more application group identifiers; and
store the configured second identifier and the unique value of the second identifier in a data structure in the load balancer component.

5. The computer system of claim 1, wherein the one or more requests are initiated via one or more web browsers, and wherein the one or more requests include the header information embedded with the combination of the first identifier and the unique value of the first identifier.

6. The computer system of claim 1, wherein the routine to bypass the maintenance mode and directing the one or more requests to establish the connection with the one or more applications is executed, when the intelligent control unit determines that the combination of the first identifier and the unique value of the first identifier extracted from the header information matches the second identifier and the unique value of the second identifier retrieved from the data structure in the load balancer component.

7. The computer system of claim 1, wherein the routine to execute the maintenance mode of the one or more applications is executed, when the intelligent control unit determines that the combination of the first identifier and the unique value of the first identifier is not present in the header information.

8. The computer system of claim 1, wherein directing the one or more requests to the maintenance mode for the one or more applications includes displaying a user interface including information related to the maintenance mode of the one or more applications.

9. The computer system of claim 1, wherein the intelligent control unit is configured to execute one or more operations based on one or more rules configured for executing the one or more requests, wherein the one or more rules are configured by a combination of one or more relational operator and one or more logical operators.

10. A non-transitory computer readable storage medium tangibly storing instructions, which when executed by a computer, cause the computer to execute operations comprising:
receive one or more requests to establish a connection with one or more applications at a load balancer component;
upon receiving the one or more requests, instantiate an intelligent control unit in the load balancer component; and
in response to a determination, the instantiated intelligent control unit determining whether:
to execute a routine to bypass a maintenance mode and direct the one or more requests to establish the connection with the one or more applications; or
to execute a routine related to the maintenance mode of the one or more applications.

11. The non-transitory computer readable storage medium of claim 10, further cause the computer to execute operations comprising:
a request processing and inspection unit at the load balancer component to:
preprocess the received one or more requests, wherein the preprocessing includes parsing the one or more requests including a content and a header information in the one or more requests;
extract the header information from the one or more requests; and
forward the extracted header information from the one or more requests to the intelligent control unit.

12. The non-transitory computer readable storage medium of claim 10, further cause the computer to execute operations comprising:
from the forwarded header information, determine whether the header information includes a combination of a first identifier and a unique value of the first identifier;
determine one or more attributes in the received one or more requests at the intelligent control unit, wherein the one or more attributes are associated with one or more user identifiers, and one or more application group identifiers; and
based on the determined one or more attributes in the received request in the one or more requests and the determined header information, determine the response by the intelligent control unit.

13. The non-transitory computer readable storage medium of claim 10, further cause the computer to execute operations comprising:
for one or more users, selectively configure a second identifier and a unique value of the second identifier based on the one or more user identifiers and the one or more application group identifiers; and
store the configured second identifier and the unique value of the second identifier in a data structure in the load balancer component.

14. The non-transitory computer readable storage medium of claim 10, wherein the one or more requests are initiated via one or more web browsers, and wherein the one or more requests include the header information embedded with the combination of the first identifier and the unique value of the first identifier.

15. The non-transitory computer readable storage medium of claim 10, wherein the routine to bypass the maintenance mode and directing the one or more requests to establish the connection with the one or more applications is executed, when the intelligent control unit determines that the combination of the first identifier and the unique value of the first identifier extracted from the header information matches the second identifier and the unique value of the second identifier retrieved from the data structure in the load balancer component.

16. The non-transitory computer readable storage medium of claim 10, wherein the routine to execute the maintenance mode of the one or more applications is executed, when the intelligent control unit determines that the combination of the first identifier and the unique value of the first identifier is not present in the header information.

17. The non-transitory computer readable storage medium of claim 10, wherein directing the one or more requests to the maintenance mode for the one or more applications includes displaying a user interface including information related to the maintenance mode of the one or more applications.

18. The non-transitory computer readable storage medium of claim 10, wherein the intelligent control unit is configured to execute one or more operations based on one or more rules configured for executing the one or more requests, wherein the one or more rules are configured by a combination of one or more relational operator and one or more logical operators.

19. A computer implemented method to bypass a maintenance mode for an application, comprising:
receiving one or more requests to establish a connection with one or more applications at a load balancer component;
upon receiving the one or more requests, instantiating an intelligent control unit in the load balancer component; and
in response to a determination, the instantiated intelligent control unit determining whether:
to execute a routine to bypass a maintenance mode and direct the one or more requests to establish the connection with the one or more applications; or
to execute a routine related to the maintenance mode of the one or more applications.

20. The computer implemented method of claim 19, further comprising:
preprocessing the received one or more requests, wherein the preprocessing includes parsing the one or more requests including a content and a header information in the one or more requests;
extracting the header information from the one or more requests; and
forwarding the extracted header information from the one or more requests to the intelligent control unit.
